(19) United States
(12) Patent Application Publication
(10) Pub. No.: US 2015/0028128 A1
(43) Pub. Date: Jan. 29, 2015

(54) ADJUSTABLE ARC OF COVERAGE CONE NOZZLE ROTARY STREAM SPRINKLER WITH STEPPED AND SPIRALED VALVE ELEMENT

(71) Applicant: Carl L.C. Kah, JR., North Palm Beach, FL (US)

(72) Inventor: Carl L.C. Kah, JR., North Palm Beach, FL (US)

(21) Appl. No.: 14/515,016

(22) Filed: Oct. 15, 2014

Related U.S. Application Data
(63) Continuation-in-part of application No. 14/293,750, filed on Jun. 2, 2014.
(60) Provisional application No. 61/829,776, filed on May 31, 2013.

(51) Int. Cl. B05B 1/32; B05B 3/02

(52) U.S. Cl. CPC B05B 1/323; B05B 3/02
USPC 239/225.1; 239/583

(57) ABSTRACT

A cone valve assembly including an upper valve member with a conical top portion and an axially stepped and spiraled top surface and a lower valve member including a central opening with a stepped and spiraled valve surface or edge surrounding the central opening. The upper valve member is mounted in the lower valve member such that the lower valve member is rotatable and axially movable relative to the upper valve member. Rotation of the lower valve member allows for the adjustment of an arcuate slot opening that provides a conically shaped discharge stream of water from the cone valve nozzle assembly directly onto the rotating distributor to provide the desired arc of sprinkler coverage.

### CROSS-REFERENCE TO RELATED APPLICATIONS

The present application is a continuation-in-part of U.S. patent application Ser. No. 14/293,750 filed Jun. 2, 2014 entitled ADJUSTABLE ARC OF COVERAGE CONE NOZZLE FOR STREAM ROTARY SPRINKLER which claims benefit of and priority to U.S. Provisional Patent Application Ser. No. 61/829,776 entitled ADJUSTABLE ARC OF COVERAGE CONE NOZZLE FOR STREAM ROTARY SPRINKLER filed May 31, 2013, the entire content of each of which is hereby incorporated by reference herein.

### BACKGROUND

1. Field of the Disclosure

The present invention relates to a cone nozzle assembly for use in a rotary nozzle sprinkler including at least one axially stepped and spiraled nozzle element to provide for discharging water directly onto a rotating self driven and channeled distributor. The nozzle assembly allows for inclusion of a throttling valve, arc of coverage setting and secondary pop-up of the rotating distributor out of the nozzle housing assembly.

2. Related Art

Generally, conventional rotary stream sprinklers do not allow for arc of coverage adjustment of more that 120 degrees, or perhaps 180 degrees, in a single nozzle assembly. Some rotary stream nozzle sprinklers that allow for partial arc adjustment require the use of a “deflector” positioned downstream of the partially adjustable arc set nozzle in order to direct the flow of water further outward from the center prior to striking the rotating channeled distributor to prevent it from striking the sealed rotating joint on the support shaft of the rotating distributor which is filled with viscous damping fluid. When a stream of water strikes the deflector downstream of the nozzle, it tends to spread, thus requiring interaction between the ends of the ribs used to form the fixed and adjustable ends of the partially adjustable arcuate opening of the partially adjustable arc of coverage nozzle with the deflector positioned downstream before water is discharged onto the rotating distributor as described in U.S. Pat. No. 6,651,905.

Accordingly, it would be beneficial to provide a nozzle assembly for use in a rotary stream nozzle sprinkler and rotary nozzle sprinkler that avoids these and other problems.

### SUMMARY

It is an object of the present disclosure to provide an adjustable, preferably an essentially fully adjustable, arc of coverage arcuate slot nozzle assembly that discharges water directly from the nozzle onto the rotating distributor to provide for improved uniformity throughout the settable arc of coverage. It is preferable to allow for upstream special pattern setting and better flow with less stream turbulence in the discharge of water onto the rotating distributor for greater range and uniformity of the stream fall out pattern. Typically, more nozzle stream turbulence causes more turbulence velocity and results in smaller drop size and the break-up of larger range streams. This limits performance of the rotary stream sprinkler uniformity in distribution, i.e. pattern performance. In accordance with the present disclosure, these problems are avoided by providing a fully arc settable nozzle configured by interaction between at least one axially stepped and spiraled nozzle element and a second stepped and spiraled valve element arranged to provide a conical water sheet at a high angle of discharge to discharge water directly onto the channeled rotating distributor. This configuration provides a cone shaped discharge sheet or stream of water that strikes the rotating distributor and fills into the channels thereof at a location where the circumference of the distributor is sufficient to completely capture the stream. That is, the depth and width of the channels at that circumference is sufficient to accommodate the flow rate through the adjustable arcuate slot. The distance that the rotating distributor is positioned above the arcuate adjustable slot relates to the best discharge angle as well as the slot width, which determines the flow rate per unit of circumference and sprinkler precipitation rate. This allows for adequate performance even at low flow rates.

It is an object of the present disclosure to provide a simple and easy to manufacture cone nozzle assembly that includes a small diameter upper valve member and a lower concentric valve member in which the upper member is mounted. The upper valve member includes an upper portion with a conical top portion having an axially stepped and spiraled underside valve surface and with a cone angle selected to be optimum for discharging a sheet of water onto the under side of a multiple channel rotating distributor which distributes water outwardly from the sprinkler. The lower valve member is selectively rotated around a center of rotation and movable axially with respect to the upper valve member and may include either an axially stepped and spiraled surface or a radially stepped and spiraled edge to interact with the upper valve element. The cone nozzle assembly provides an adjustable length nozzle slot or opening for selecting an arc of coverage and discharging an outwardly coned thin sheet of water onto the multiple channel rotating distributor, which is rotatably mounted above the nozzle assembly.

An advantage of the cone nozzle assembly of the present disclosure is that because its apex inlet end has a minimum diameter, it allows for maximum slot width, which reduces clogging at low flow rates. That is, the sprinkler of the present application allows for reliable operation even at low flow rates. Also, the valve member may include a concentric support shaft that protrudes downwardly through alignment ribs at the cone nozzle inlet end and provide for selective flow restriction, if desirable, for pattern tailoring and for continuous concentric alignment of the upper and lower cone valve members during the opening and closing of the arcuate slot or opening around the circumference of the interacting stepped and spiraled portions of the valve members.

A sprinkler head in accordance with an embodiment of the present disclosure includes a base, a conical adjustable nozzle defining an adjustable arcuate discharge orifice, a rotating distributor supported on a shaft extending upwardly from said base, and adapted to be impinged by a stream emitted from the nozzle and an arc adjustment ring rotatably mounted on said base, said arc adjustment ring operatively connectable with said nozzle to adjust said arcuate discharge orifice.

A nozzle assembly in accordance with an embodiment of the present application includes an upper valve member including a conical top portion with an axially stepped and spiraled underside valve surface and a lower valve member including a central opening and a radially stepped and spiraled edge surrounding the central opening, the upper valve member mounted in the lower valve member such that the lower valve member is movable relative to the upper valve member such that interaction between the axially stepped and spiraled underside valve surface of the upper valve member and the radially stepped and spiraled edge of the lower valve member defines an arcuate slot of a desired length to provide a conically shaped water discharge stream over a desired arc of coverage when water flows through the valve assembly.

A sprinkler head nozzle assembly in accordance with an embodiment of the present disclosure includes a nozzle housing including an inlet for pressurized water and an outlet downstream of the inlet, a rotating arc adjustment ring mounted on the nozzle housing such that rotation of the arc adjustment ring extends and reduces an arcuate exit opening to set an arc of coverage of the sprinkler head nozzle assembly, and a rotating distributor, mounted on a central shaft extending through an arcuate adjustable nozzle including a valve assembly positioned below the rotating distributor in the nozzle housing and operable to direct water onto the rotating distributor. The valve assembly includes an upper valve element including a top portion with a conical axially stepped and spiraled underside valve surface and a lower valve member including a central opening and a radially stepped and spiraled edge surrounding the central opening, the upper valve member mounted in the lower valve member such that the lower valve member is movable relative to the upper valve member such that interaction between the axially stepped and spiraled underside valve surface of the upper valve member and the radially stepped and spiraled edge of the lower valve member defines the arcuate exit opening to provide a conically shaped water discharge stream over a desired arc of coverage when water flows through the valve assembly.

A sprinkler head nozzle assembly in accordance with an embodiment of the present application includes a nozzle housing including an inlet for pressurized water and an outlet downstream of the inlet; a rotating arc adjustment ring mounted on the nozzle housing such that rotation of the arc adjustment ring extends and reduces a length of an arcuate exit opening to set an arc of coverage of the sprinkler head nozzle assembly and a rotating distributor, mounted on a central shaft extending through an arcuate adjustable nozzle including a valve assembly positioned below the rotating distributor in the nozzle housing and operable to direct water onto the rotating distributor. The valve assembly includes an upper valve element including a top portion with a conical axially stepped and spiraled underside valve surface and a lower valve member including a central opening, the lower valve member including one of an axially stepped and spiraled upper surface and a radially stepped and spiraled edge surrounding the central opening, the upper valve member mounted in the lower valve member such that the one of the lower valve member and the upper valve member is rotatable and movable axially with respect to the other of the upper valve member and lower valve member such that interaction between the axially stepped and spiraled underside valve surface of the upper valve member and one of the axially stepped and spiraled surface and radially stepped and spiraled edge of the lower valve member defines the arcuate exit opening to provide a conically shaped water discharge stream over a desired arc of coverage when water flows through the valve assembly.

Other features and advantages of the present invention will become apparent from the following description of the invention, which refers to the accompanying drawings.

### BRIEF DESCRIPTION OF THE DRAWINGS

FIG. 1 shows a cross-sectional elevation view of a nozzle housing of a rotary stream sprinkler including a cone valve assembly in accordance with an embodiment of the present disclosure with the cone valve assembly open on one side and closed on the other side and the rotating distributor mounted on its shaft at its non-operating, retracted position above the adjustable arc cone valve assembly.

FIG. 1A illustrates a cross-sectional view of the nozzle housing of FIG. 1 rotated clockwise showing the flow slot.

FIG. 1B illustrates a cross sectional view of an alternative embodiment of a fully arc of coverage adjustable nozzle assembly including an axially stepped and spiraled upper valve member and a radially stepped and spiraled lower valve member.

FIG. 1C is a more detailed view of the nozzle assembly illustrated in FIG. 1B.

FIG. 2 shows a cross-sectional view of the nozzle housing of the rotary stream sprinkler of FIG. 1 with the arc settable stepped and spiral cone valve assembly in the fully shut off position, but with the rotating distributor positioned in its operating position in the nozzle housing so that the discharge water angle is shown where it would strike the rotating distributor including a lower valve member as illustrated in FIG. 3 described below.

FIG. 2A shows a cross-sectional view of the nozzle housing of the rotary stream sprinkler of FIG. 1B with the arc settable stepped and spiral cone valve assembly in the fully shut off position, but with the rotating distributor positioned in its operating position in the nozzle housing so that the discharge water angle is shown where it would strike the rotating distributor including a lower valve member.

FIG. 2B illustrates a cross sectional elevation view of the nozzle assembly illustrated in FIG. 1C with the nozzle in a fully shut off position.

FIG. 2C shows a more detailed view of the nozzle assembly of FIG. 2B.

FIG. 3 shows a perspective view of a lower valve member with upstream flow restriction fingers.

FIG. 3A shows the same perspective view of the lower valve member without the upstream flow restriction fingers.

FIG. 3B illustrates the lower valve element of FIG. 2B.

FIG. 4 shows a perspective view of an embodiment of the upper valve member of FIG. 1.

FIG. 4A shows a perspective view of the upper valve member of FIGS. 1B and 2B.

FIG. 5 illustrates a perspective view looking into the top of the cone valve assembly of FIG. 2 set at approximately 270 degrees to provide a 270 degree segment of outwardly coned cylindrical sheet of water.

FIG. 5A illustrates a perspective view looking into the top of the cone valve assembly of FIGS. 1B and 2B set at approximately 180 degrees to provide a 180 degree segment of outwardly coned cylindrical sheet of water and also illustrates indices indicating an increase direction and decrease direction for an upstream flow throttling ring.

FIG. 6 shows a cross-sectional elevation view of a rotary nozzle sprinkler assembly complete with a pressure actuated lower piston and retraction spring compressed and the rotating distributor extended out of its nozzle housing in its operating position including the nozzle assembly of FIG. 2.

FIG. 7 shows the same operational position of the sprinkler of FIG. 6 with the nozzle assembly shown with its left side open to discharge a cone shaped stream of water onto the underside of the rotating distributor shown in its extended operating position.

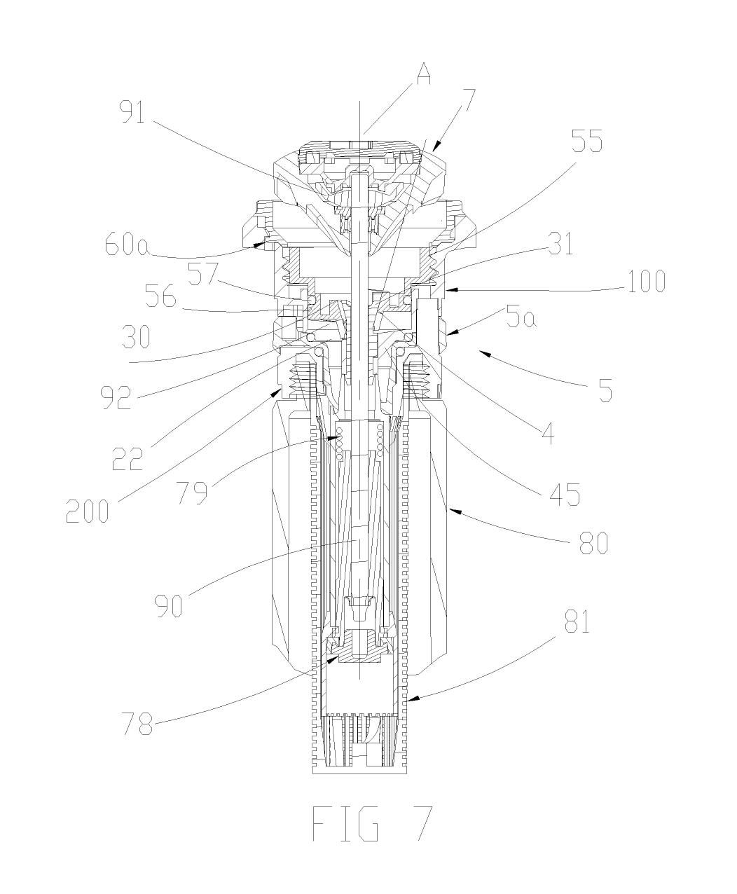

FIG. 8 shows a cross-sectional elevation view of a rotary nozzle sprinkler assembly in its operating position complete with a pressure actuated lower piston and retraction spring compressed and the rotating distributor extended out of its nozzle housing in its operating position including the nozzle assembly of FIG. 2B.

### DETAILED DESCRIPTION OF THE EMBODIMENTS

U.S. patent application Ser. No. 12/348,864 filed Jan. 5, 2009 entitled ARC AND RANGE OF COVERAGE ADJSUTABLE STREAM ROTOR SPRINKLER provides a description of the general configuration and operation of a rotary stream nozzle sprinkler and is incorporated by reference herein in its entirety. Some of the problems implicit in the operation of conventional rotary stream sprinklers are discussed above

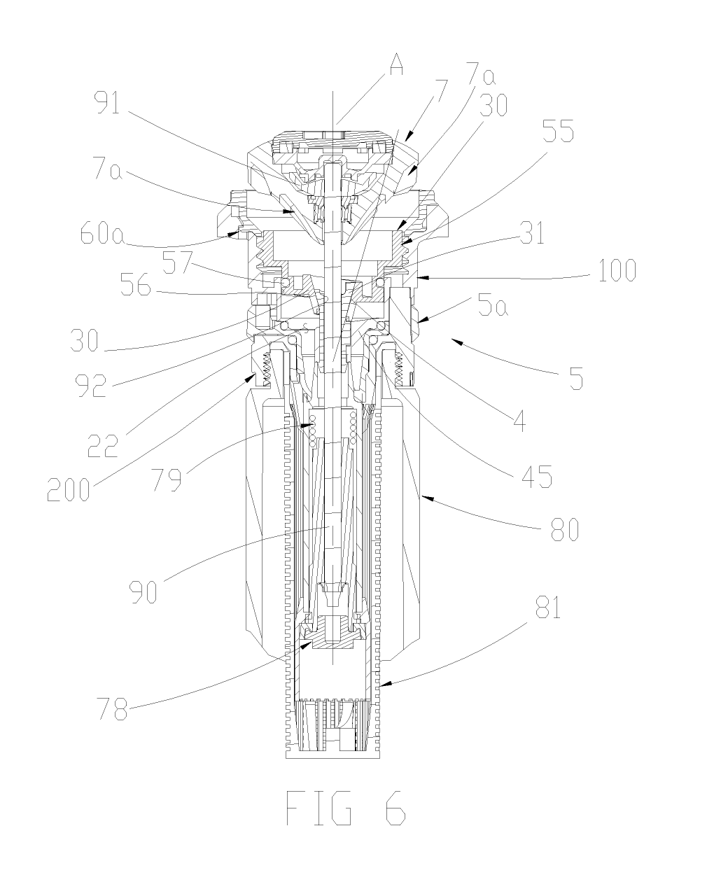

The cone valve nozzle assembly 3 of the present disclosure may be configured to be incorporated into the above-referenced stream rotor sprinkler configuration and is preferably provided in nozzle housing assembly 5, which may be attached to the top of a riser assembly 80 in a pop-up type sprinkler, as shown in FIG. 6, for example. A filter 81 may be included, if desired. The threads 200d of the lower nozzle housing member 200 of nozzle housing assembly 5 may be used to engage corresponding threads on a riser 80 of such a pop-up type sprinkler in a conventional manner. Nozzle housing assembly 5 also includes upper nozzle housing member 100.

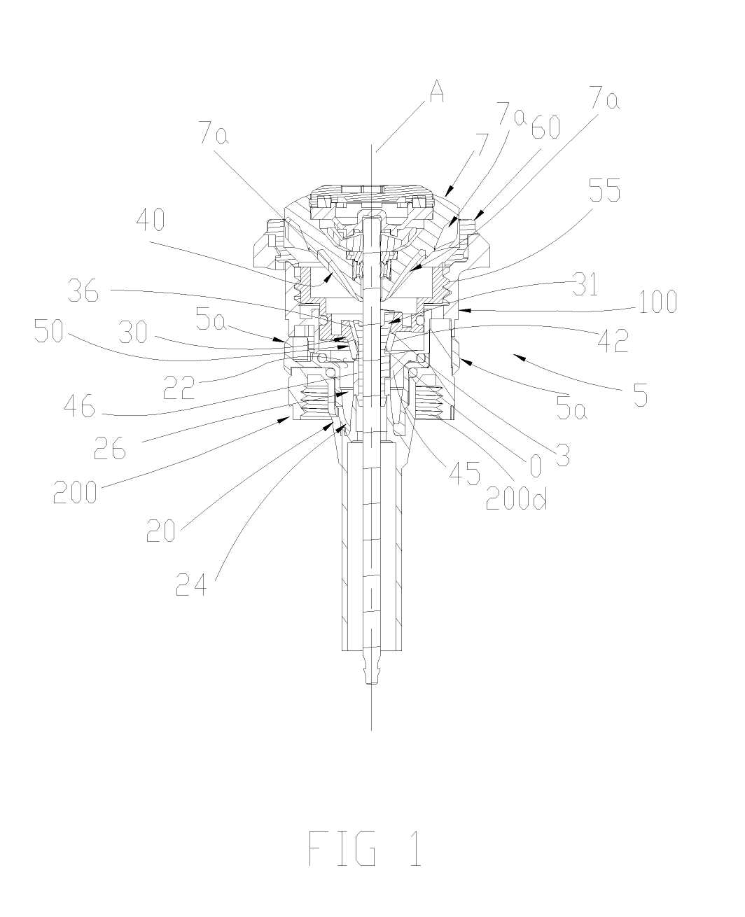

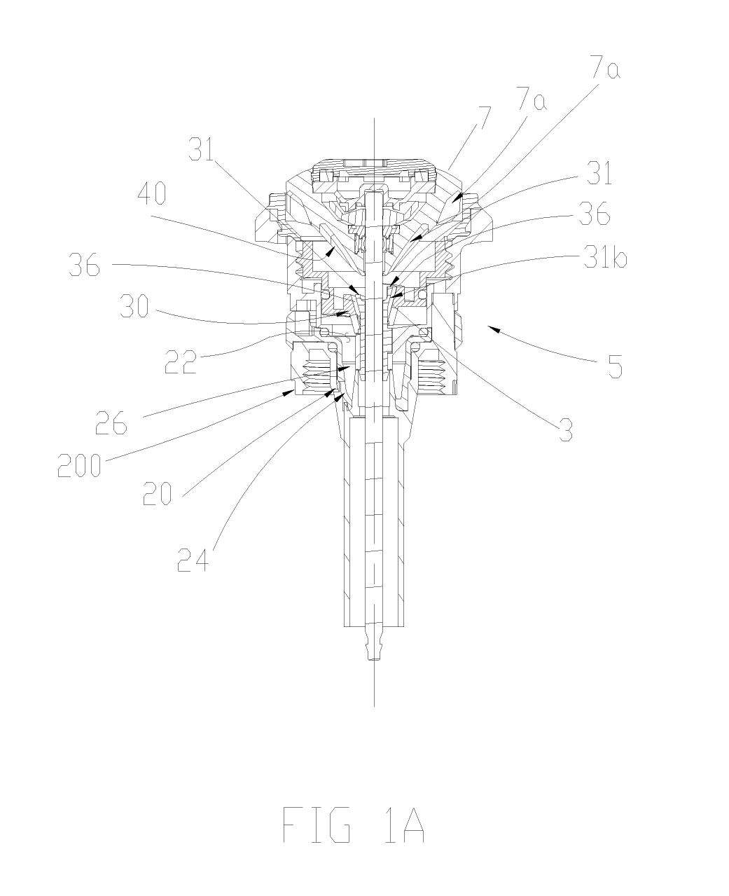

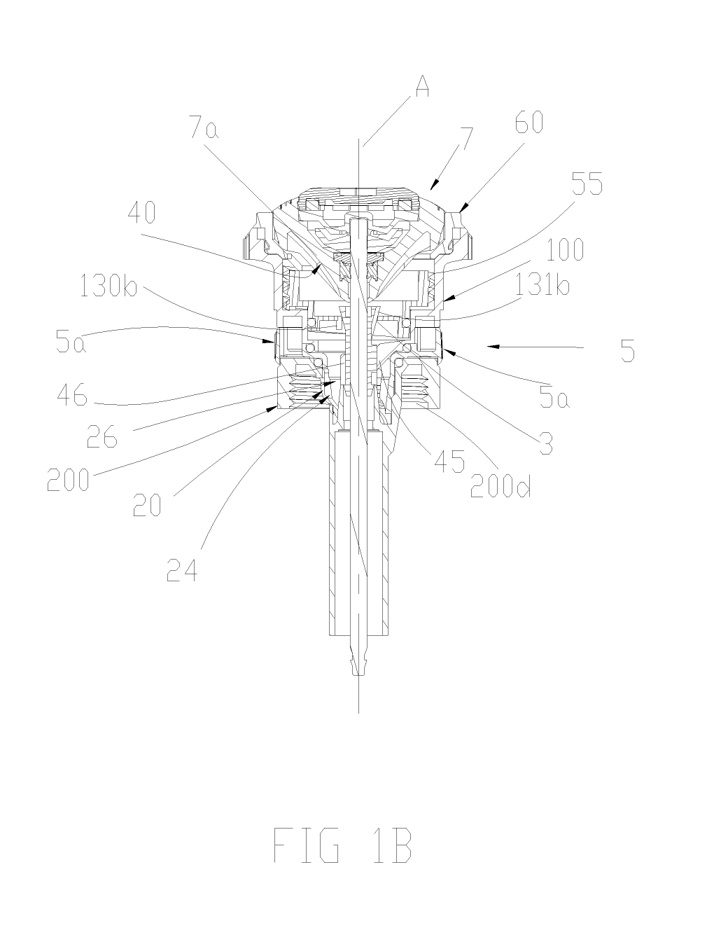

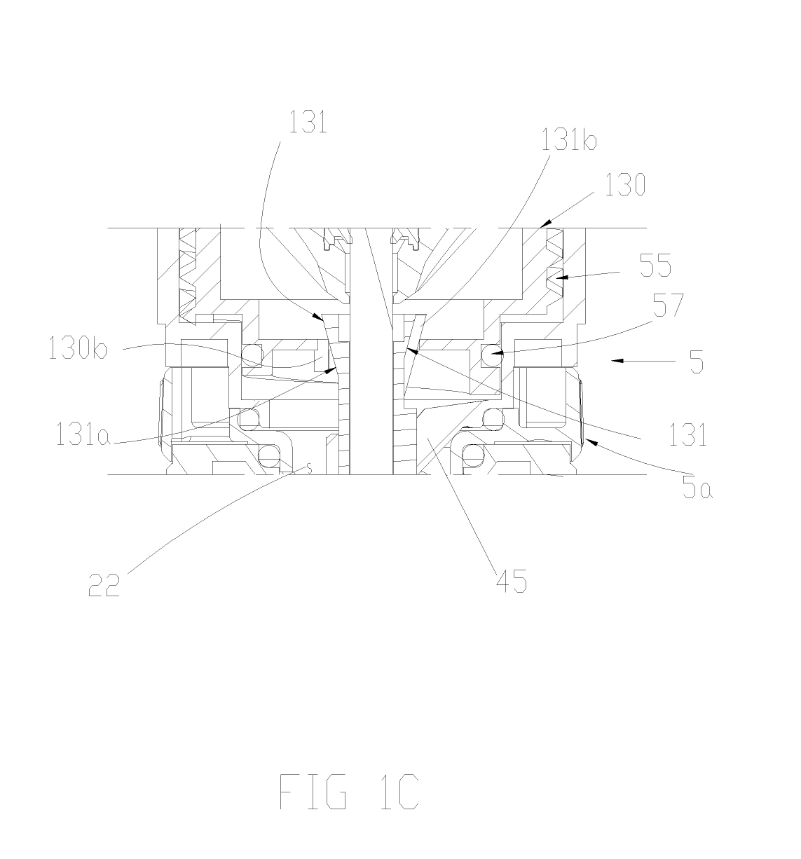

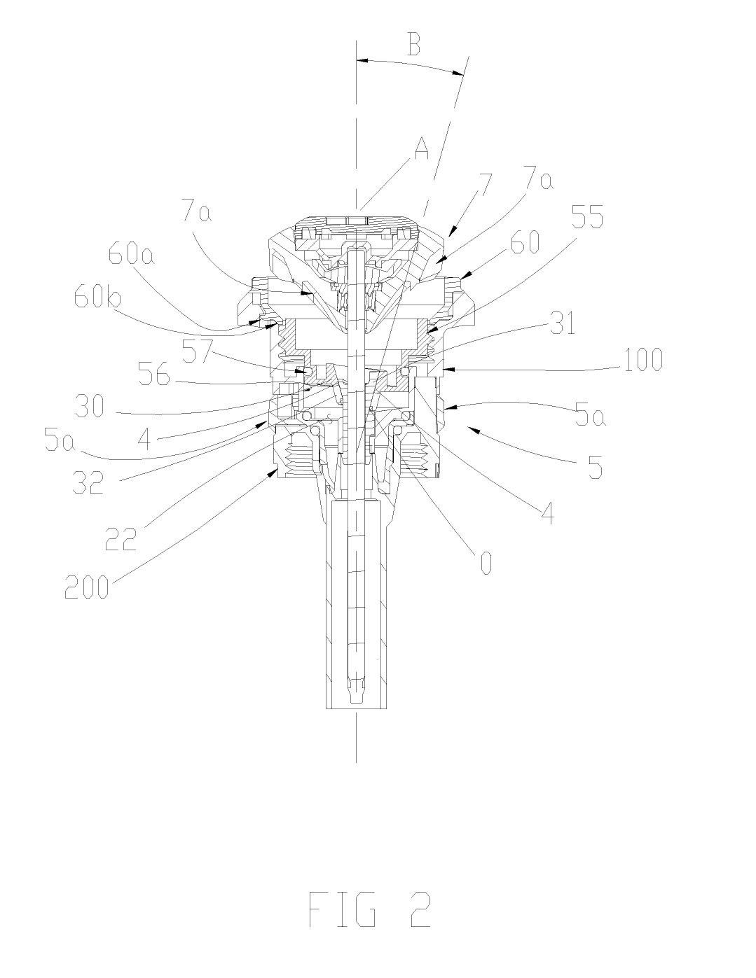

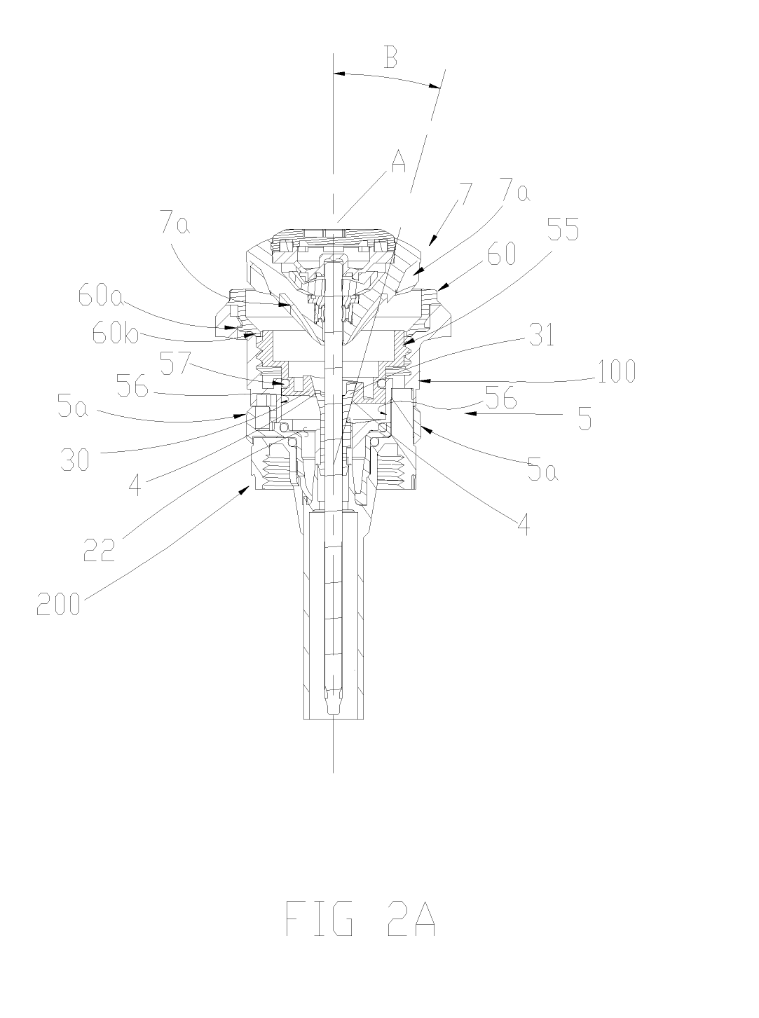

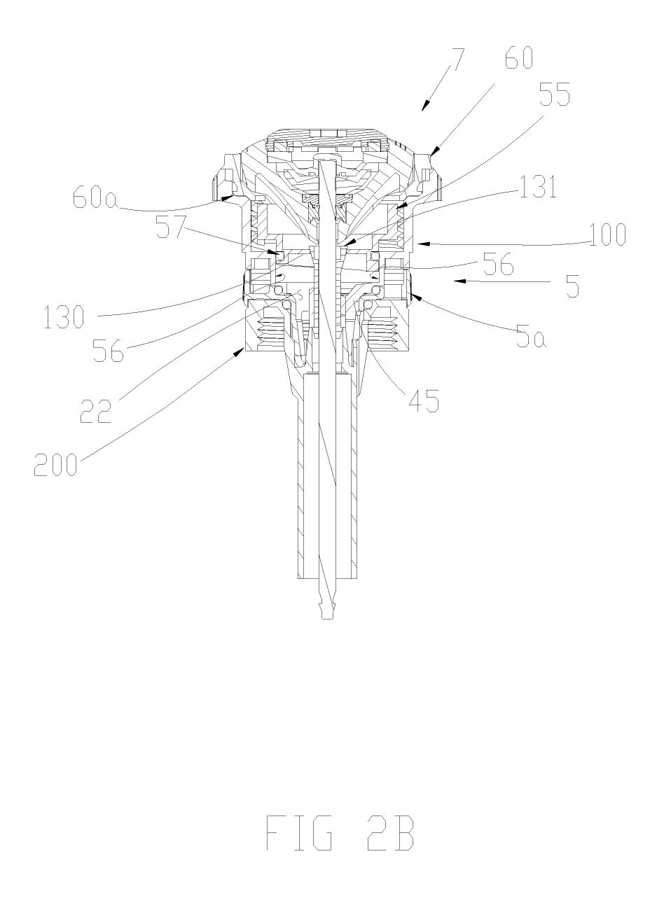

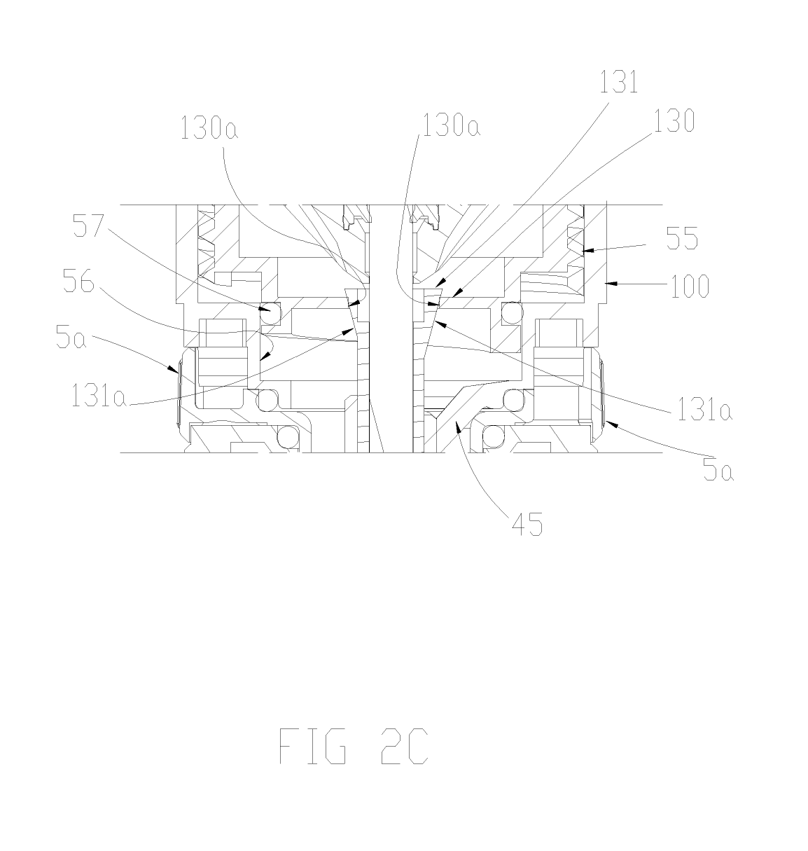

As can be seen in FIG. 1, for example, in an embodiment, the cone valve assembly 3 includes upper and lower valve members 31, 30, respectively, and provides water discharge from the nozzle housing 5 at a desired angle B, relative to the central axis A of the nozzle assembly, as shown in FIG. 2, for example, such that water strikes the rotating distributor 7 at a best or desired stream angle desired, to provide a more efficient sprinkler. The angle B is preferably between about 11 and 17 degrees. Specifically, water flows along the conical outer and inner surfaces of the top portion of the arcuate upper valve member 31 and lower valve member 30 as indicated at 4 in FIG. 2, for example, to discharge water onto the rotating distributor 7 at the desired angle. Providing the nozzle discharge in a cone shape at a desirable angle for striking the rotating stream distributor 7 provides optimum uniformity of the sheet of water striking the distributor, and thus, avoids distortions in the output of the sprinkler.

As can be seen with reference to FIG. 1, for example, the water flow enters the central volume of the stream nozzle housing 5 via openings shown at 20. As noted above, the nozzle housing may be mounted on the top of a riser of a pop-up sprinkler that extends from a base when water is supplied. See FIG. 6, for example. The water may pass through the upstream flow-throttling member 26, specifically through the opening(s) 24 formed therein, and into an internal volume 22 just upstream of the arcuate adjustable cone nozzle assembly 3. The nozzle assembly 3 is illustrated in a closed position in FIG. 2. The flow slot passage 36 is shown open on the left side of in FIG. 1 and discharges water upwardly and outwardly at the desired or optimum angle for contacting the bottom surface 40 of the distributor 7. The distributor 7 further collects the stream of water into channels 7a of selected widths to distribute selective columns of water radially outward with selected stream channel exit elevation angles to provide the proper and uniform water distribution outwardly around the sprinkler using the nozzle assembly 3.

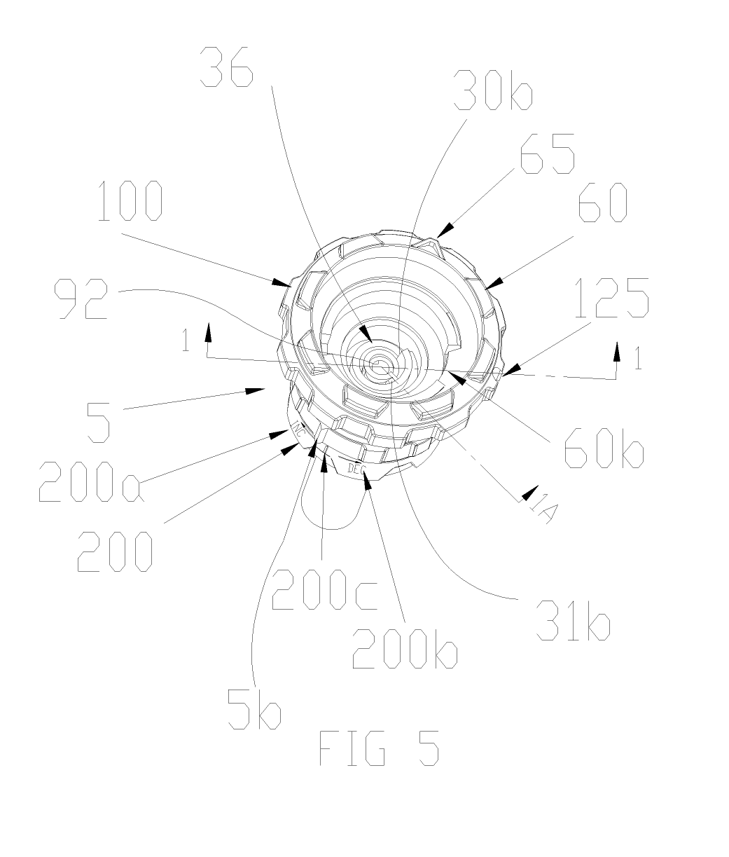

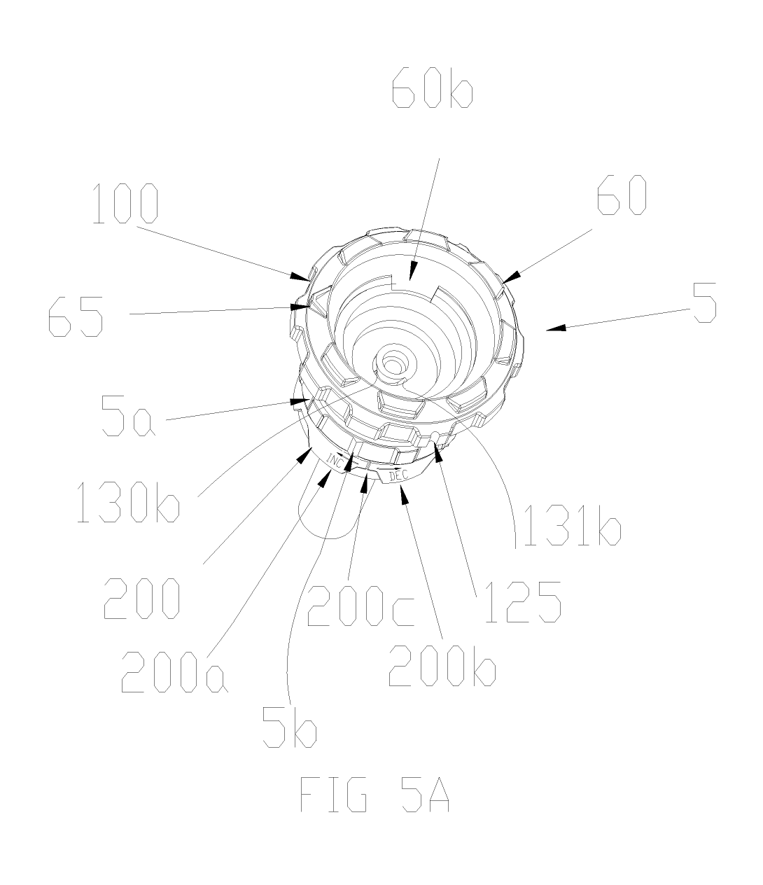

FIG. 1A illustrates the same nozzle housing of FIG. 1 rotated clockwise with the cross sectional view taken along the line 1A illustrated in FIG. 5. The line labeled 1 in FIG. 5 corresponds to cross-sectional view in FIG. 1. FIG. 1A illustrates the wall step 31b on the left side thereof with the slot 36 for water passage extending to both sides of the upper valve member 31.

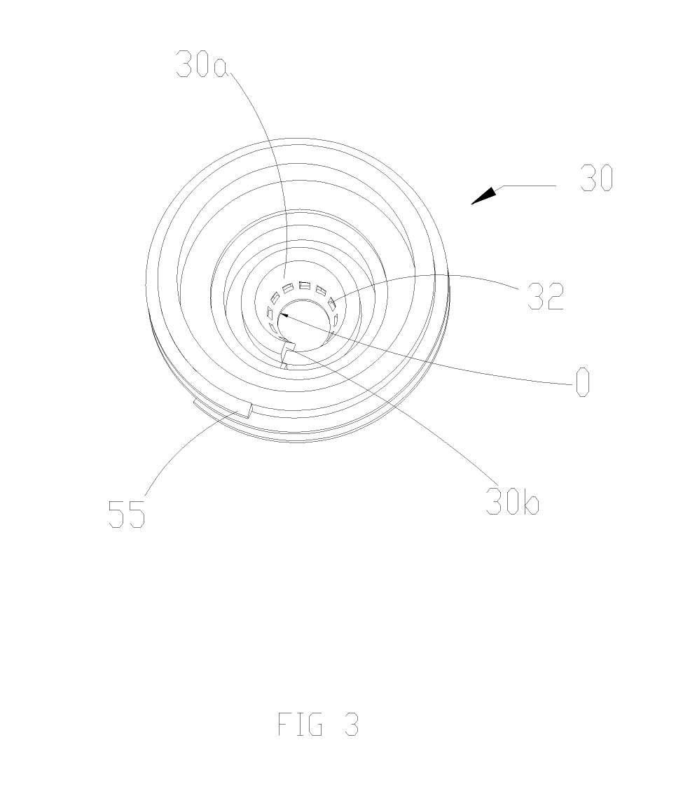

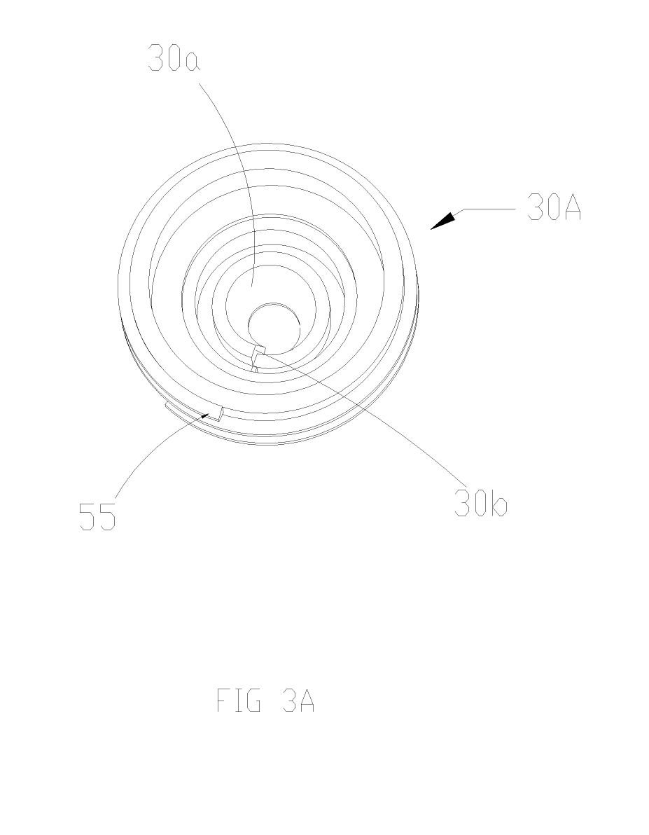

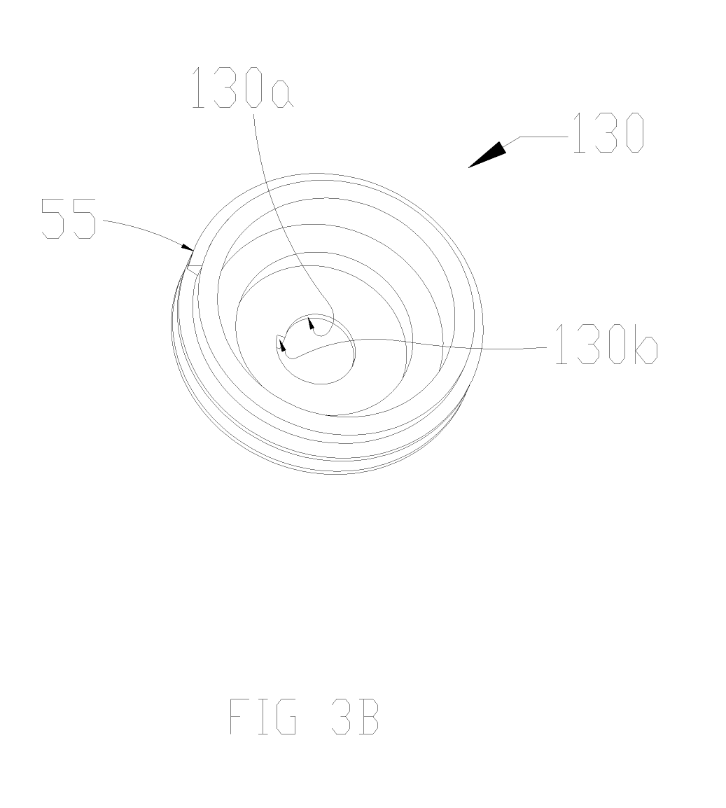

It is desirable that the water sheet or stream that is discharged from the valve assembly 3 have a uniform circumference, since as the rotating distributor 7 rotates, different stream channels of different widths interact with the sheet of water. Different distributions of the flow around the circumference may be achieved for selected patterns with the upstream entrance of the water at 50 by the flow reducing fingers 32 (See FIG. 3), if desired. These flow reducing fingers, however, need not be present, as illustrated in FIG. 3A, for example.

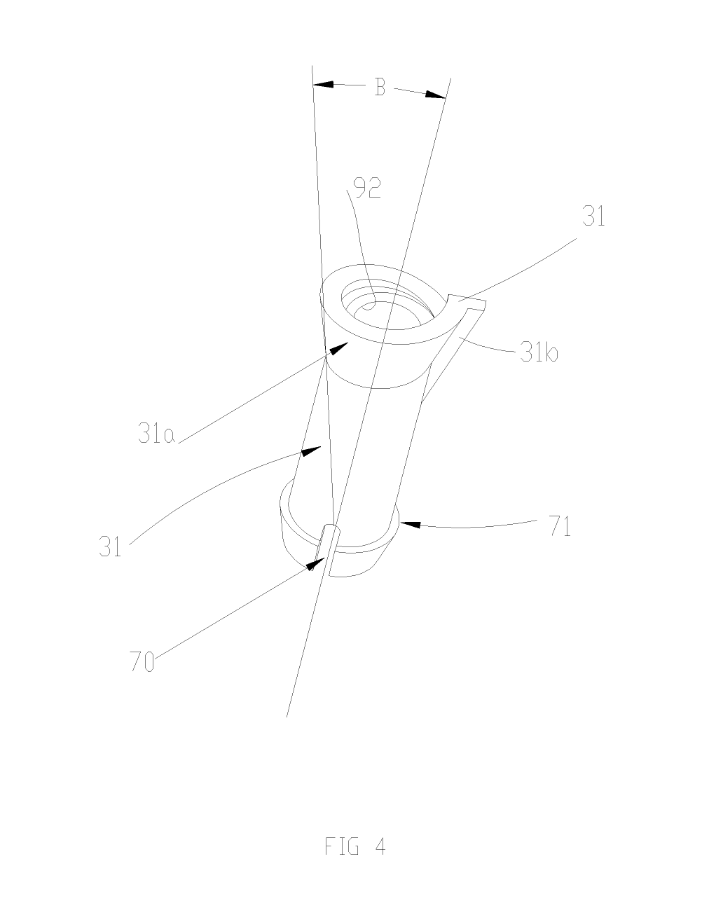

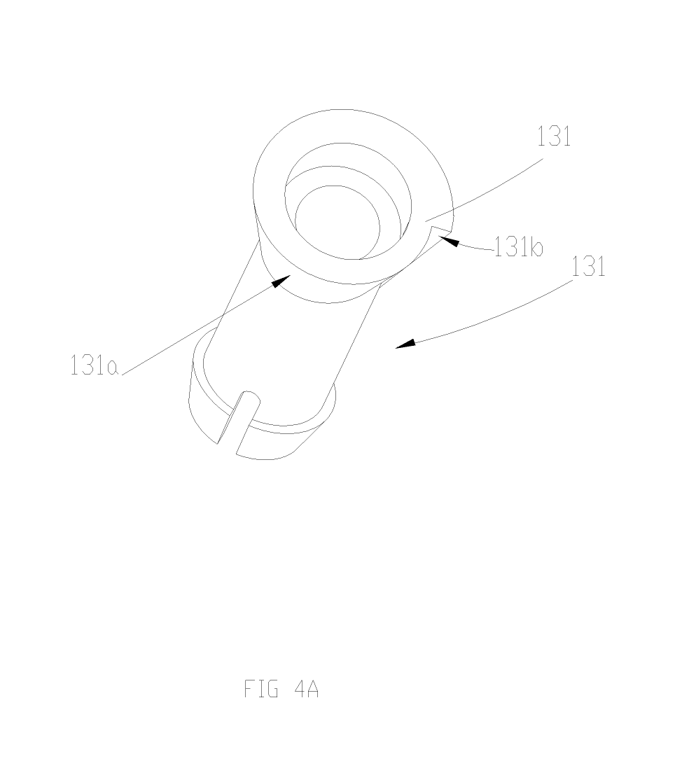

The upper valve member 31 and the upper stepped and spiraled underside surface 31a thereof are shown in perspective in FIG. 4 as well as the surface 31b which becomes the fixed end of the adjustable slot 36 as the lower valve member 30 is rotatable clockwise. See FIG. 5, for example. The surface 30b becomes the movable end of the slot 36.

The lower valve member 30 and the lower stepped and spiraled top valve surface 30a surrounding the opening O is shown in perspective in FIG. 3. The lower valve member 30 is held in proper constant axial position by the pitch of its housing thread and cylindrical seal surface 56 during sprinkler operation via mounting threads 55 and surface 56. An O-ring 57 provides the seal with the surface 56 to ensure a seal during axial movement. The lower valve member 30 may be selectively moved axially up or down by rotation of the arc adjustment ring 60 to modify the arc of coverage of the sprinkler. Rotation of the arc adjustment ring 60 rotates the lower valve member 30 such that the threads 55 provide for axial movement of the lower valve member to exactly match the pitch of the matching upper and lower stepped and spiraled cone shaped nozzle valve surfaces 31a, 30a.

The axial and rotational movement of the lower valve member 30 causes the circumferential nozzle slot opening 36 to be increased, or decreased, as desired to provide the desired arc of coverage. Water passes through the opening 36 to provide a sheet of nozzle discharge water that strikes the rotating distributor 7, which further directs the water radially outward for circumferential distribution around the sprinkler utilizing the nozzle assembly 3. This axial movement allows for modification of the arc of coverage of the sprinkler over any arc from 0 degrees up to 360 degrees. It is noted that generally, an arc of coverage of about 60 degrees is desirable to ensure rotation of the distributor 7. The viscosity of the viscous material used in the viscous braking element 91 (See FIG. 6, for example) may be selected to ensure rotation at lower arc's of coverage as well.

The outer arc adjustment ring 60 is snapped into a grove as shown at 60a in FIG. 2 and rotationally connected to the lower valve member 30 via a leg as shown at 60b in FIG. 5, for example. Since the ring 60 is always in contact with the lower valve member 30, the position of the ring 60 may be used to indicate the arc of coverage that is presently set, even when not in operation. In a preferred embodiment, an indicator 65 is provided on the top surface of the ring 60, the position of which relative to a reference element 125 on the upper housing element 100 indicates the arc of coverage that is set. See FIG. 5, for example.

In FIG. 4, the upper valve member 31 is illustrated. The circumference break clearance slot 70 is illustrated at the bottom of support shaft 46. This slot allows the snap edge, or lip, 71 at the bottom of the upper valve member 31 to compress while being inserted into the opening O of the lower valve member 30 and to pop open at the bottom at the desired axial position in the upper nozzle housing 100, to hold the upper valve member at the desired axial position and fixed rotational position. Thus, the upper valve member 31 is fixed rotationally and axially as rotation of the lower valve member 30 is used to control the arc of coverage of the stream of water exiting the valve 3.

FIG. 5 illustrates a top view of the cone valve assembly 3 set to provide water distribution over an arc of 270 degrees. That is, as illustrated the opening 36 is provided such that the sprinkler using the cone nozzle valve assembly 3 will provide distribution of water over a 270-degree arc around the sprinkler between edge 31b of the upper valve member 31 and edge 30b of the lower valve member 30. As noted above, rotation of the lower valve member 30 causes the circumferential nozzle slot opening 36 to be increased, or decreased, as desired by the user to adjust the arc of coverage, which may be indicated by the position of the notch 125 on the fixed upper housing member 100 relative to the point shaped indicator 65 on the rotating arc adjustment ring 60.

FIGS. 5 and 5A also illustrates indices “Increase” and “Decrease” positioned relative to the flow control ring 5a. The flow control ring 5a may be used to provide upstream flow throttling which results in range adjustment as well. The nominal range setting is indicated at 200c on the lower nozzle housing element 200. The “Increase” indicia for increasing range and flow is indicated at 200a and the “Decrease” indicia for decreasing range and flow is indicated at 200b. That is, to increase flow and range, the ring 5a should be rotating in the direction indicated by the “Increase” indicia, while decreasing flow and range is accomplished by rotating the ring in the direction indicated by the “Decrease” indicia. Element 5b of the ring 5a is used to show the relative position of the ring 5a relative to the nominal setting indicated at 200c.

FIG. 6 illustrates a rotary nozzle sprinkler assembly 1 complete with its pressure actuated lower piston 78 and retraction spring 79 compressed and with the rotating distributor 7 extended out of its nozzle housing 5 in its operating position. The distributor 7 includes a viscous brake assembly 91 to limit rotational speed of the distributor. The viscous brake assembly 91 generally includes a chamber in the deflector 7 filled with a viscous fluid. The shaft 90 extends into the chamber through a seal, or seals, and a bearing, or bearings, that allows the deflector 7 to rotate relative to the shaft 90. A stator is fixedly connected to the shaft in the chamber such that the stator remains stationary while the distributor rotates to limit the speed of rotation. In a preferred embodiment, nozzle housing assembly 5 is mounted on top of riser 80 which is preferably movably mounted in a base connected to a water supply. The lower nozzle housing member 200 includes flow-throttling member 26 which may be used to limit flow through the openings 24 as discussed above. Upper nozzle housing member 100 is provided above the lower member 200 with the nozzle assembly 3, including upper and lower valve members 31, 30 mounted therein. The flow control ring 5a is preferably rotatably mounted between the upper and lower housing members 100, 200 and rotates to control flow through the openings 24. The arc set ring 60 is mounted on top of the upper member 100 and is operably connected to the lower valve member 30 to rotate the lower valve member and move the lower valve member axially as noted above at 60b. See FIGS. 2, 5 and 5A, for example. The ring 60 is secured in a slot as indicated at 60a. The center clearance hole 92 in the upper valve member support shaft 46 allows the shaft 90 to pass through the valve assembly 3 to extend the distributor 7 or to allow spring 79 to retract the distributor 7 into the upper nozzle housing member 100.

FIG. 1B illustrates an alternative configuration of a nozzle housing in which the valve assembly 3 includes an axially stepped and spiraled upper valve member 131 and a radially stepped and spiraled lower valve member 130. The upper valve member 131 is configured and operates in substantially the same manner as the upper valve member 31 described above. The lower valve member 130 operates in a similar manner as the valve member 30 described above in that it is rotatable to allow for axial movement relative to the upper valve member 131, but includes a radially stepped and spiraled edge surface, as noted above. FIG. 1C shows a more detailed view of the upper and lower valve elements 131, 130 of FIG. 1C. FIG. 2B illustrates the valve assembly of FIG. 1B in the fully shut off position and FIG. 2C shows a more detailed view of the valve assembly in FIG. 2B. FIG. 3C illustrates a perspective view of the lower valve member 130 in which the radial spiral and stepped edge thereof is clearly illustrated. FIG. 4 illustrates the upper valve element 131.

FIG. 5A illustrates a perspective view of the nozzle assembly of FIG. 1B looking down with the arc of coverage set between the surfaces 131b and 130b of the upper and lower valve elements 131, 130 at approximately 90 degrees. In operation, rotating the lower valve element 130 results in axial movement thereof, similar to that described above. Interaction between the lower surface 131a of the upper valve 131 and the radially stepped and spiraled edge of the lower valve element 130 controls the slot 36 through which water passes. As the lower valve element 130 rotates, it moves axially with respect to the upper valve element 131 such that the slot 36 width can be maintained. The relative position of the surfaces 131b and 130b of the lower and upper valve elements 131, 130 defines the length of the slot to provide a desired arc of coverage around the sprinkler assembly. The resulting stream output from the nozzle assembly 3 has conical shape and is directed at the rotating distributor 7 to provide watering over the set arc of coverage. As noted above, the arc of coverage may be indicated by indicator 65 on the top of the ring 60.

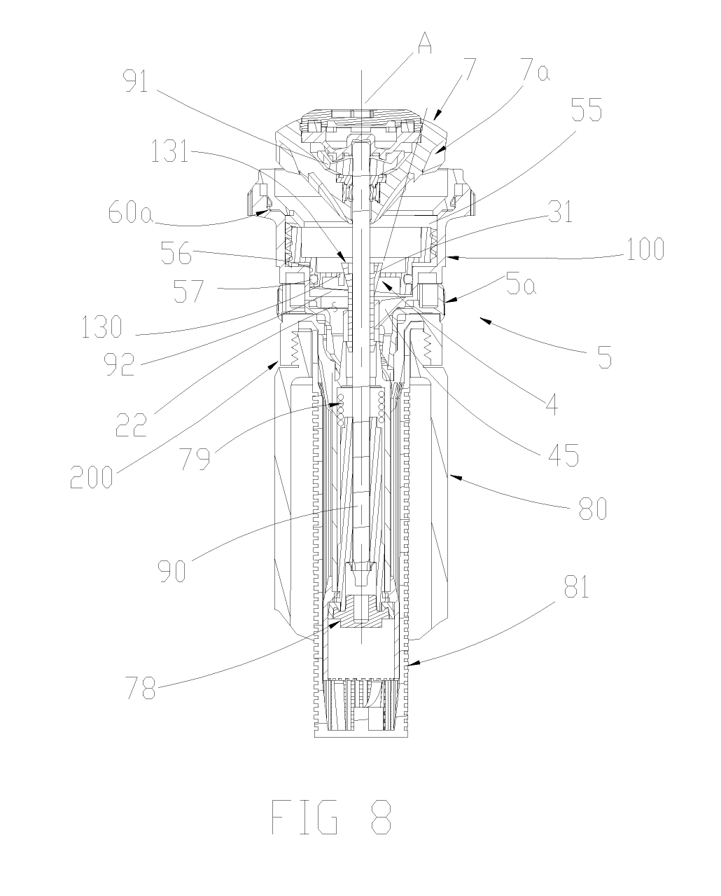

FIG. 8 illustrates the nozzle assembly of FIG. 1B in a sprinkler including pressure actuated lower piston 78 and retraction spring 79 with the distributor 7 extended in its operative position. Water passes through the valve assembly 3 and exits in a conical stream that contacts the distributor 7 at the angle B discussed above. The water is distributed around the sprinkler in a manner to provide the desired precipitation pattern over the desired arc of coverage.

In either embodiment, the valve assembly 3 of the present application provides a conical stream of water that strikes the distributor 7 in an optimal manner to provide for uniform coverage of the desired arc. There is no need to provide a deflector downstream of the nozzle assembly to redirect the flow thereof because the nozzle assembly provides the stream of water at the optimal angler relative to the distributor 7. This results in a uniform watering patter with minimum distortions.

Although the present invention has been described in relation to particular embodiments thereof, many other variations and modifications and other uses will become apparent to those skilled in the art.

What is claimed is:

1. A valve assembly for use in a rotary stream sprinkler comprises:
an upper valve member including a conical top portion with an axially stepped and spiraled underside valve surface; and
a lower valve member including a central opening and a radially stepped and spiraled edge surrounding the central opening, the upper valve member mounted in the lower valve member such that the lower valve member is movable axially relative to the upper valve member such that interaction between the stepped and spiraled underside valve surface of the upper valve member and the stepped and spiraled edge of the lower valve member defines an adjustable arcuate slot of a desired height and length to provide a conically shaped nozzle water discharge stream over a desired arc of coverage when water flows through the valve assembly.

2. The valve assembly of claim 1, wherein the upper valve member is mounted in the lower valve member such that the upper valve member remains in a fixed axial position and cannot rotate.

3. The valve assembly of claim 2, wherein the upper valve member includes a circumferential locking lip extending around a bottom portion of the upper valve member to prevent axial movement of the upper valve member.

4. The valve assembly of claim 3, further comprising an adjustment slot extending parallel to a central axis of the nozzle assembly at a bottom of the upper valve member such that the bottom of the upper valve element, including the circumferential locking lip resiliently deforms and extends outward when the upper valve element reaches a desired position.

5. The valve assembly of claim 2, wherein the upper valve member includes a tab extending radially outward from the outer surface of the upper valve member and positioned parallel to a central axis of the nozzle assembly and configured to prevent rotation of the upper valve member.

6. The valve assembly of claim 1, wherein the conical top portion of the stepped and spiraled underside valve surface of the upper valve member extends at the desired angle relative to a central axis of the valve assembly to direct water at the desired angle.

7. The valve assembly of claim 6, wherein the desired angle is 17 degrees.

8. The valve assembly of claim 1, further comprising an arc adjustment ring, operably connected to the lower valve member and rotatable about a central axis of the nozzle assembly to move the lower valve member.

9. The valve assembly of claim 8, wherein the arc adjustment ring is operably connected to the lower valve member such that the lower valve member rotates with the arc adjustment ring and moves axially, parallel to the central axis of the valve assembly, to adjust the height and length of the arcuate slot.

10. The valve assembly of claim 1, further comprising an upstream throttling element positioned upstream from the lower valve member and upper valve member to control flow of water to the lower and upper valve members.

11. A sprinkler head nozzle assembly comprising:
a nozzle housing including an inlet for pressurized water and an outlet downstream of the inlet;
a rotating arc adjustment ring mounted on the nozzle housing such that rotation of the arc adjustment ring extends and reduces a length of an arcuate exit opening to set an arc of coverage of the sprinkler head nozzle assembly;
a rotating distributor, mounted on a central shaft extending through an arcuate adjustable nozzle including a valve assembly positioned below the rotating distributor in the nozzle housing and operable to direct water onto the rotating distributor;
the valve assembly further comprising:
an upper valve element including a top portion with a conical axially stepped and spiraled underside valve surface; and
a lower valve member including a central opening and a radially stepped and spiraled edge surrounding the central opening, the upper valve member mounted in the lower valve member such that the lower valve member is movable relative to the upper valve member such that interaction between the axially stepped and spiraled underside valve surface of the upper valve member and the stepped and spiraled edge of the lower valve member defines the arcuate exit opening to provide a conically shaped water discharge stream over a desired arc of coverage when water flows through the valve assembly.

12. The sprinkler head assembly of claim 1 further comprising a rotating range adjustment ring mounted on the housing upstream of the arc adjustment ring such that rotation of the range adjustment ring increases and decreases a downstream flow area to control flow of water to the arcuate exit opening.

13. The sprinkler head nozzle assembly of claim 11, wherein the arc adjustment ring has a snap retention lug for attachment to the nozzle housing to allow rotation relative to the nozzle housing while being retained.

14. The sprinkler head nozzle assembly of claim 13, wherein the nozzle housing has an arc set ring retention slot adjacent to the arc adjustment ring snap retention lug.

15. The sprinkler head nozzle assembly of claim 14, wherein rotation of the arc adjustment ring changes a length of the arcuate exit opening.

16. The sprinkler head nozzle assembly of claim 12, wherein the range adjustment ring includes an upstream adjustable area opening in the nozzle housing flow path to the nozzle assembly.

17. The sprinkler head nozzle assembly of claim 11, wherein the nozzle housing includes an actuation piston for extending and retracting the rotating distributor out of the nozzle housing.

18. The sprinkler head nozzle assembly of claim 11, wherein the rotating distributor includes a viscous damping assembly operable to limit rotational speed of the rotating distributor.

19. The sprinkler head assembly of claim 11, wherein the set arc of coverage and the set range are visible from an exterior of the sprinkler head assembly.

20. A sprinkler head comprising:
a base;
a conical adjustable nozzle defining an adjustable arcuate discharge orifice;
a rotating distributor supported on a shaft extending upwardly from said base, and adapted to be impinged by a stream emitted from the nozzle; and
an arc adjustment ring rotatably mounted on said base, said arc adjustment ring operatively connectable with said nozzle to adjust said arcuate discharge orifice.

21. The sprinkler head of claim 19, wherein the conical adjustable nozzle includes:
an upper valve element including a top portion with a conical axially stepped and spiraled underside valve surface; and
a lower valve member including a central opening and an radially stepped and spiraled top valve surface surrounding the central opening, the upper valve member mounted in the lower valve member such that the lower valve member is movable relative to the upper valve member such that interaction between the axially stepped and spiraled top valve surface of the upper valve member and the lower radially stepped and spiraled edge of the lower valve member define said arcuate discharge orifice to provide a conically shaped water discharge stream over a desired arc of coverage when water flows through the conical adjustable nozzle.

22. The sprinkler head of claim 21, wherein the lower valve member is continuously operably connected to the arc adjustment ring and configured such that rotation of the arc adjustment ring allows for adjustment of an arcuate length of the discharge orifice between 0° and up to 360°.

23. The sprinkler head of claim 21, wherein the lower valve member includes an indicator positioned on a top surface thereof such that a position of the indicator indicates the arcuate length of the discharge orifice.

24. The sprinkler head of claim 19, wherein the shaft is normally stationary and the distributor rotates relative to said shaft.

25. The sprinkler head of claim 24, wherein the distributor is mounted for rotation about the shaft and formed with an interior chamber defined by upper and lower bearings and an interior surface of the distributor and a stator fixed to the shaft and located within the chamber, where the chamber is at least partially filled with a viscous fluid.

26. The sprinkler head of claim 25, including drag ridges on interior surfaces of the interior chamber.

26. The sprinkler head of claim 21, wherein a center clearance hole is formed through a center of the upper and lower valve elements for the shaft and a water pressure actuatable piston is provided in the lower nozzle housing to act on the shaft and pop the rotating deflector upward under the force of water pressure.

28. The sprinkler head of claim 26, including a coil spring around the shaft and biased against movement of the water pressure actuatable piston, the coil spring at a location that is vented to atmospheric pressure.

29. A sprinkler head nozzle assembly comprising:
a nozzle housing including an inlet for pressurized water and an outlet downstream of the inlet;
a rotating arc adjustment ring mounted on the nozzle housing such that rotation of the arc adjustment ring extends and reduces a length of an arcuate exit opening to set an arc of coverage of the sprinkler head nozzle assembly;
a rotating distributor, mounted on a central shaft extending through an arcuate adjustable nozzle including a valve assembly positioned below the rotating distributor in the nozzle housing and operable to direct water onto the rotating distributor;
the valve assembly further comprising:
an upper valve element including a top portion with a conical axially stepped and spiraled underside valve surface; and
a lower valve member including a central opening, the lower valve member including one of an axially stepped and spiraled upper surface and a radially stepped and spiraled edge surrounding the central opening, the upper valve member mounted in the lower valve member such that the one of the lower valve member and the upper valve member is rotatable and movable axially with respect to the other of the upper valve member and lower valve member such that interaction between the axially stepped and spiraled underside valve surface of the upper valve member and one of the axially stepped and spiraled surface and radially stepped and spiraled edge of the lower valve member defines the arcuate exit opening to provide a conically shaped water discharge stream over a desired arc of coverage when water flows through the valve assembly.
